(19) United States
(12) Patent Application Publication
(10) Pub. No.: US 2015/0067066 A1
(43) Pub. Date: Mar. 5, 2015

(54) Provisioning Communication Services using Proxy Server in a Cloud

(71) Applicant: Saurabh Radhakrishnan, Los Altos, CA (US)

(72) Inventor: Saurabh Radhakrishnan, Los Altos, CA (US)

(21) Appl. No.: 14/011,003

(22) Filed: Aug. 27, 2013

(51) Int. Cl. H04L 12/58

(52) U.S. Cl. CPC H04L 51/06
USPC 709/206

(57) ABSTRACT

A method and system for provisioning a communication service using a proxy server in a cloud. The method includes engaging a service provider network and a cloud in a zero-rated service level agreement (SLA). Further, the method includes receiving a message and compressing content of the received message into plain text. The method further includes detecting one or more attachments associated with the message and removing the one more attachments from the message. Furthermore, the method includes inserting one or more links to the one or more removed attachments into the message and routing the message to one or more receivers in accordance to the zero-rated SLA.

### FIELD OF INVENTION

The present invention generally relates to communication services, and more particularly to a mechanism for provisioning communication services using zero-rated service level agreement (SLA) in a cloud.

### BACKGROUND OF INVENTION

With the advent of electronic devices such as mobile phone, computer, and the like, electronic communication is generally used as a common means of communication among each other, particularly, with the use of smart phones including various communication applications. Examples of such communication can include for example, but not limited to, email, instant messaging, social network communication, broadcast communication, 2-way communication, distributed communication, clustered communication, and the like. An electronic communication often includes one or more attachments. Most of the communication servers and clients are generally associated with low-cost and limited bandwidth Internet services. The use such electronic communications with attachments, particularly related to emails, for such servers and clients may significantly increases the overall network usage cost. Further, this may inefficient for the servers and clients associated with low or limited bandwidth.

Different systems and methods are proposed to provide the effective email services at low-cost. One mechanism allows a sender to register at a website-based upload service, and upload all attachments to their account at that website-based upload service. The upload service provides a link address that accesses the uploaded file(s). Subsequently, the sender logs out of the upload service account, returns to their local email application, and drafts an email addressed to the recipient by manually including a textual link to that file. In another mechanism, an intermediately server can be used to receive the emails, remove the attachments from the email, insert links to the attachments into the email, and route the email with the links to the recipient(s). Such mechanisms may uses either a separate service or a intermediately server to upload and download the attachments, which may increases the network usage cost either at server end or at the client end.

Further, while effective, such mechanisms may include limitations inherent in the conventionally communication services. For instance, different rules from different communication systems and organizations may likely be applied. Moreover, size limits may vary between the sender and receivers email server. As a result, the users often must resort to other techniques and systems to transfer large files. Furthermore, such mechanisms may not provide a secure means for transferring attachments. Thus, there is a need for a simple, robust, reliable, and efficient system and method for provisioning communication services at reasonable system cost.

### SUMMARY

Accordingly the invention provides a method for provisioning a communication service using a proxy server in a cloud. The method includes engaging a service provider network and the cloud in a zero-rated service level agreement (SLA). Further, the method includes receiving a message and compressing content of the received message into plain text. The method further includes detecting one or more attachments associated with the message and removing the one more attachments from the message. Furthermore, the method includes appending one or more links to the one or more removed attachments into the message and routing the message to one or more receivers in accordance to the zero-rated SLA. Furthermore, the method includes charging the one or more receiver for the message in accordance to the zero-rated SLA.

In an embodiment, the zero-rated SLA specifies zero-rate for traffic exchange between the service provider network and the cloud. In an embodiment, the communication service includes for example, but not limited to, an email service, instant messaging service, social network communication service, broadcast communication service, 2-way communication service, distributed communication service, clustered communication service, and the like. In an embodiment, the message includes for example, but not limited to, an email message, instant message, multimedia message, notification message, alert message, and the like. In an embodiment, the message is sent by a sender associated with the service provider network. In an embodiment, the message is received by the proxy server. In an embodiment, the proxy server acts as a man-in-the-middle server between the sender and the receiver associated with the service provider network.

Furthermore, the method includes establishing a connection between the proxy server and the network service associated with the sender in accordance to the zero-rated SLA. Furthermore, the method includes establishing a connection between the proxy server and the network service associated with the receiver in accordance to the zero-rated SLA. Furthermore, the method includes storing the identified attachment on the proxy server. Furthermore, the method includes downloading the attachment from the proxy server using the link and charging the receiver for downloading the attachment in accordance to the zero-rated SLA. Furthermore, the method includes providing a communication access point to route all traffic from the receiver to the proxy server. Furthermore, the method includes providing the communication access point to route all traffic from the sender to the proxy server. In an embodiment, the communication access point is provided by the service provider network.

Accordingly the invention provides a system for provisioning a communication service using a cloud. The system includes a proxy server configured to engage a service provider network and the cloud in a zero-rated service level agreement (SLA). Further, the proxy server is configured to receive a message and compress content of the received message into plain text. Furthermore, the proxy server is configured to detect one or more attachments associated with the message and remove the one more attachments from the message. Furthermore, the proxy server is configured to append one or more links to the one or more removed attachments into the message and route the message to one or more receivers in accordance to the zero-rated SLA. Furthermore, the proxy server is configured to charge the one or more receiver for the message in accordance to the zero-rated SLA.

Furthermore, the proxy server is configured to establish a connection between the proxy server and the network service associated with the sender in accordance to the zero-rated SLA. Furthermore, the proxy server is configured to establish a connection between the proxy server and the network service associated with the receiver in accordance to the zero-rated SLA. Furthermore, the proxy server is configured to store the identified attachment on the proxy server. Furthermore, the proxy server is configured to download the attachment from the proxy server using the link and charge the receiver for downloading the attachment in accordance to the zero-rated SLA. Furthermore, the proxy server is configured to provide a communication access point to route all traffic from the receiver to the proxy server. Furthermore, the proxy server is configured to provide the communication access point to route all traffic from the sender to the proxy server.

Accordingly the invention provides a computer program product for provisioning a communication service using a proxy server in a cloud. The computer program product includes an integrated circuit. The integrated circuit includes a processor, a memory including a computer program code within the circuit. Further, the memory and the computer program code with the processor cause the product to engage a service provider network and the cloud in a zero-rated service level agreement (SLA). Furthermore, the memory and the computer program code with the processor cause the product to receive a message and compress content of the received message into plain text. Furthermore, the memory and the computer program code with the processor cause the product to detect one or more attachments associated with the message and remove the one more attachments from the message. Furthermore, the memory and the computer program code with the processor cause the product to append one or more links to the one or more removed attachments into the message and route the message to one or more receivers in accordance to the zero-rated SLA. Furthermore, the memory and the computer program code with the processor cause the product to append one or more links to the one or more removed attachments into the message and route the message to one or more receivers in accordance to the zero-rated SLA. Furthermore, the memory and the computer program code with the processor cause the product to append one or more links to the one or more removed attachments into the message and route the message charge the one or more receiver for the message in accordance to the zero-rated SLA. Furthermore, the memory and the computer program code with the processor cause the product to download the one or more attachment from the proxy server using the link and charge the receiver for downloading the one or more attachments in accordance to the zero-rated SLA.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF DRAWINGS

This invention is illustrated in the accompanying drawings, throughout which like reference letters indicate corresponding parts in the various figures. The embodiments herein will be better understood from the following description with reference to the drawings, in which:

FIG. 1 is a diagram illustrating, among other things, a high level overview of a system, according to embodiments as disclosed herein;

FIG. 2 is a diagram illustrating, among other things, another implementation of the system as described in the FIG. 1, according to embodiments disclosed herein;

FIG. 3 is a sequence diagram illustrating different operations performed by the of the system as described in the FIGS. 1 and 2, according to embodiments disclosed herein;

FIG. 4 is a flow chart illustrating a method for provisioning communication services using a proxy server in a cloud, according to embodiments disclosed herein; and

FIG. 5 depicts a computing environment implementing the system and method, in accordance with various embodiments of the present invention.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

The embodiments herein achieve a method and system for provisioning communication services using a proxy server in a cloud. In an embodiment, the method includes engaging service provider network and cloud in a zero-rated service level agreement (SLA). Unlike conventional system, the zero-rated SLA described herein specifies a zero-rate information associated with traffic exchange between the service provider network and the cloud such that the service provider cannot charge for the traffic to-and-from the cloud. The proxy server can be configured to receive a message. The message described herein can include for example, but not limited to, email message, instant message, multimedia message, notification message, and alert message. The message may include a body and attachment(s). The proxy server can be configured to compress the body of the message into plain text, detect one or more attachments associated with the message, remove the one or more attachments from the message, insert one or more links to the one or more attachments into the message, and route the message to receiver(s) in accordance to the zero-rated SLA. Unlike conventional systems, the proxy server can be situated in the cloud such that the receiver receive the email and download the attachment using the link without incurring bandwidth and other charges to the service provider.

The method and system disclosed herein is dynamic, robust, and reliable for provisioning communication services using the zero-rated SLA in the cloud. Unlike conventional systems, the use of the zero-rated SLA enables the proxy server to combine with service provider data plans such that the users can pay for an email only data plan. The zero-rated SLA engages the service providers not to charge for the operations/traffic incoming or outgoing from the cloud. Unlike conventional systems, by compressing the message and removing the attachments from the messages, the proposed system and method may reduces the overall bandwidth usage of the user in various ways. For example, it may enable faster download of the non-attachment portions of the message. Further, the use of the zero-rated SLA provides the users to pay only for the message (which is also very less in size). For example, when the user receive the email and download the attachment using the link, the user will not be charged by the service provider as the service provider is engaged with the zero-rated SLA for the operations performed in the cloud. The proposed system and method can be used to leverage common clients, standards, and protocols for communication services and the web, using server-side intelligence to deliver content to the user over poor-performance network environments at a reasonable system cost. The system and method can be particularly used in the wireless environment where network usage cost is expensive and speeds are slow. Furthermore, the proposed system and method can be implemented using existing infrastructure, components, and modules, and may not require extensive set-up or instrumentation.

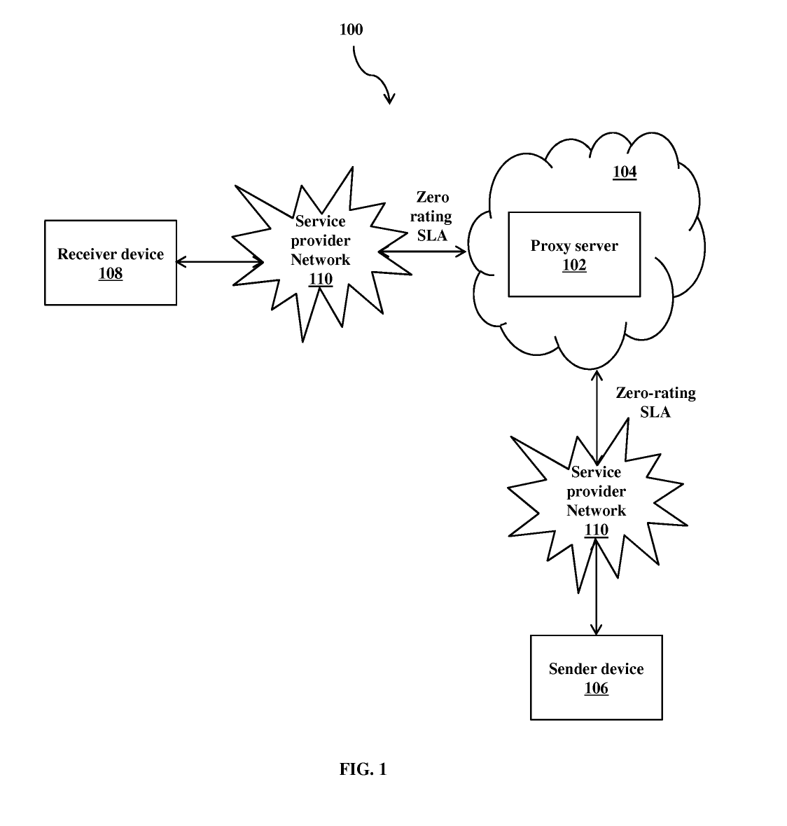

Referring now to the drawings, and more particularly to FIGS. 1 through 5, where similar reference characters denote corresponding features consistently throughout the figures, there are shown preferred embodiments.

FIG. 1 is a diagram illustrating, among other things, a high level overview of a system 100, according to embodiments as disclosed herein. In an embodiment, service provider networks supply services relating to the global Internet, and hence, are herein referred to as Internet Service Providers (ISPs). In other words, the term Internet Service Provider (ISP) generally pertains to a particular type of network service provider that concentrates on providing access to the global Internet. It is to be understood by any person skilled in the art that the present invention can be applicable for any type of packet-switched network.

As shown in the FIG. 1, the system 100 includes a proxy server 102 in a cloud 104, sender device 106, and receiver device 108, communicating among each other over service provider network(s) 110. In an embodiment, the service provider network(s) 110 described herein can include for example, but not limited to, wireless network, a wire line network, global system for mobile communication, cellular network, public network such as Internet, private network, personal network, local area network, wide area network, a combination thereof, or any other communication network. In an embodiment, the service provider network(s) 110 can provide both a physical layer interface and a logical connection to the “cloud” 104.

In an embodiment, the proxy server 102 can be configured to receive and send communication messages among the sender device 106 and the receiver device 108. In an embodiment, the proxy server 102 described herein can be any computer system or application that acts as an intermediary for requests, from sender and receiver devices, seeking communication messages. In an embodiment, the sender device 106 and receiver device 108 described herein can include for example, but not limited to, computer, laptop, smart phone, mobile device, tablet, personal digital assistance, server, and the like. In an embodiment, the communication message described herein can include for example, but not limited to, email message, instant message, multimedia message, notification message, and alert message. The message may include a body and attachment(s).

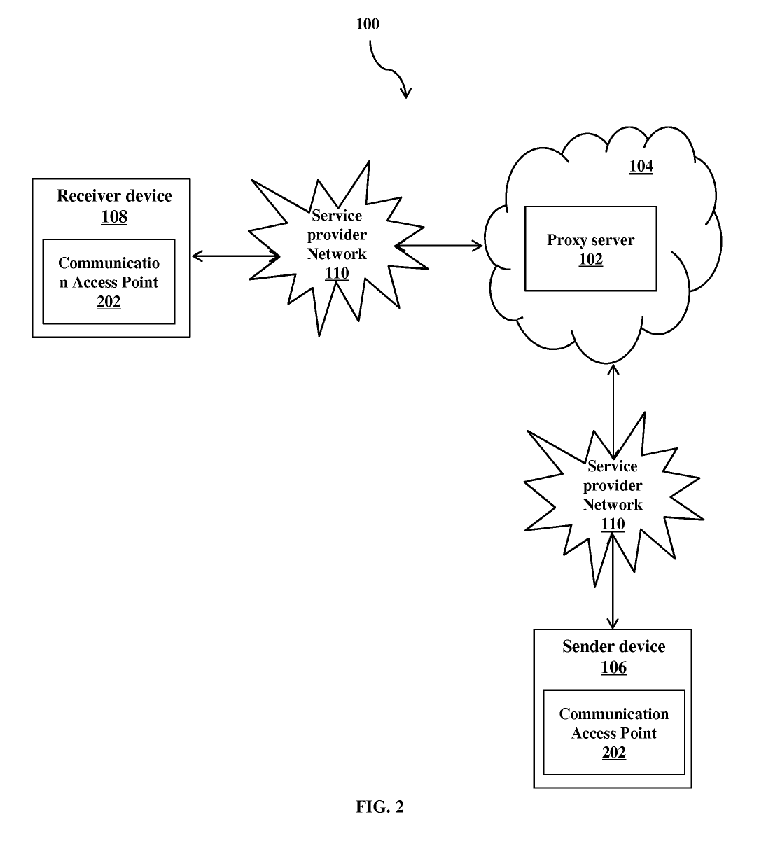

In an embodiment, the cloud 104 and the service provider network 110 can be engaged into a zero-rated service level agreement (SLA). Unlike conventional system, the zero-rated SLA described herein specifies a zero-rate information associated with traffic exchange between the service provider network and the cloud such that the service provider cannot charge for the usage of network in the cloud 104. The use of the zero-rated SLA enables the proxy server 102 to combine with the service provider data plans such that the users can pay for an email only data plan. The zero-rated SLA engages the service providers not to charge for the operations/traffic incoming or outgoing from the cloud 104. The usage cost of a connection to the cloud 104 and a particular service provider network can be a combination of the physical layer interface and the logical connection to the cloud 104 from the sender or the receiver devices. The physical interface can typically include costs for access circuits, routers, terminal servers, and other hardware the service provider or the cloud uses to connect the customer to its site. Generally, the service provider or the cloud can interconnect multiple sites with leased lines to form a backbone in a number of possible topologies. In an embodiment, the service provider can provide a connection with a communication access point (AP), such as to route all the traffic, associated with the sender device 106 or the receiver device 108, to the proxy server 102 in the cloud 104. Further, an exemplary illustration of implementing the communication AP is described in conjunction with the FIG. 2. Furthermore, a number of other components that form the logical connection for IP (Internet Protocol) service, including route announcements, address space, traffic on the backbone, and the like can be used by the cloud 104 in accordance to the zero-rated SLA.

In an embodiment, the sender device 106 can send a communication message addressed to one or more receivers using the service provider network 110. The message described herein may include a body and one or more attachment. The proxy server 102 can be configured to receive the outgoing message with attachments, and automatically removes the attachment(s) from the message and adds an Internet link (or links) to the attachment (or attachments) hosted in the cloud 104. In an embodiment, the proxy server 102 can directly receive the message from the sender device 106 or from any other server which manages the communication messages to/from the sender device 106. In an embodiment, the automatic removal and replacement of attachments with links may be a receiver configurable parameter, or may be a service provider requirement.

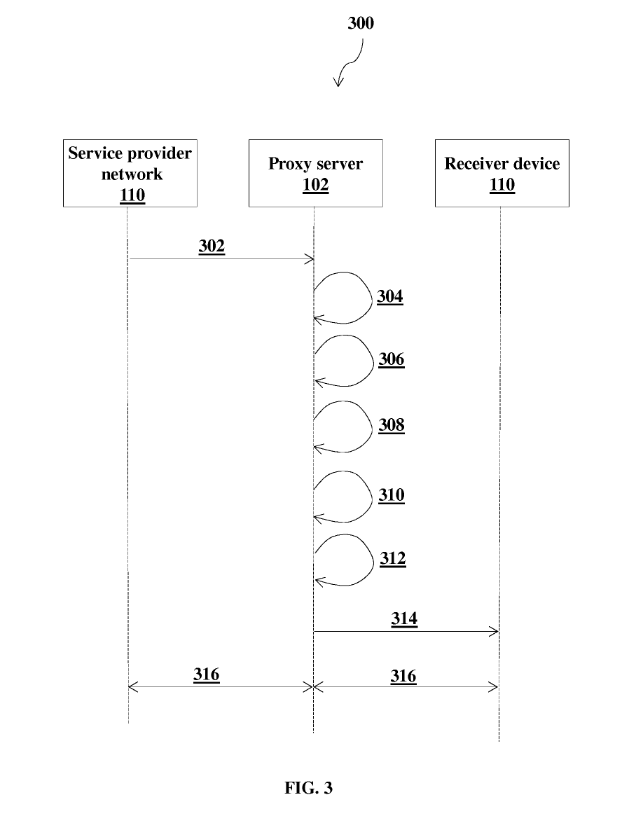

For example, the receiver preferences can determine which portions of a message the proxy server 102 treats as attachments. Unlike conventional systems, by compressing and removing the attachments from the messages, the system 100 may reduces the overall bandwidth usage of the user in various ways. For example, it may also enable faster download of attached portions of the message, accomplished both by avoiding base 64 encoding and by applying Web-compliant compression. Further, it may eliminate the need to transmit some data. Because receivers can control when or if they wish to download the attachments, not all attachments may need to be transmitted. Further, the user of the zero-rated SLA provides the users to pay only for the message (which is also very less in size). Furthermore, the various operations performed by the system 100 are described in conjunction with the FIG. 3.

Though the FIG. 1 shows only one sender device and receiver device communicating with the proxy server through the service provider network but, it is to be understood that another exemplary embodiment is not limited thereto. Further, the system 100 can include any number of sender devices and receiver devices communicating with the proxy server along with other hardware or software components. For example, the component can be, but not limited to, a process running in the controller or processor, an object, a thread of execution, a program, and/or a computer. By way of illustration, both an application running on a microcontroller/microprocessor and the microcontroller/microprocessor itself, can be components.

FIG. 2 is a diagram illustrating, among other things, another implementation of the system 100 as described in the FIG. 1, according to embodiments disclosed herein. In an embodiment, a communication access point (AP) 202 is provided to route all the traffic, associated with the sender device 106 or the receiver device 108, to the proxy server 102 in the cloud 104. Generally, most of the service providers are interested to make changes in their infrastructure, opposed to the zero-rated SLA. Unlike conventional systems, the system 100 allows the service providers to provide an option on the sender and receiver device to create a connection with the communication AP 202, such as to route all the traffic through the connection to the proxy server 102. The communication AP 202 described herein can route all type of communications such as for example, but not limited to, email, instant messaging, social network communication, broadcast communication, 2-way communication, distributed communication, clustered communication, and the like. The proxy server 102 can then be configured to receive the outgoing message with attachments, and automatically removes the attachment(s) from the message and adds an Internet link (or links) to the attachment (or attachments) hosted in the cloud 104. Further, the various operations performed by the system 100 are described in conjunction with the FIG. 3.

FIG. 3 is a sequence diagram illustrating different operations performed by the system as described in the FIGS. 1 and 2, according to embodiments disclosed herein. In an embodiment, at 302, the service provider network 110 and the cloud 104 can be engaged in the zero-rated SLA. Unlike conventional system, the zero-rated SLA specifies a zero-rate information associated with traffic exchange between the service provider network 110 and the cloud 104 such that the service provider cannot charge for the usage of network in the cloud 104. The zero-rated SLA engages the service providers not to charge for the operations/traffic incoming or outgoing from the cloud 104. In an embodiment, where the service providers are interested to make changes in their infrastructure, opposed to the zero-rated SLA, the system 100 allows the service providers to provide an option on the sender and receiver device, such as to create a connection with the communication AP 202. The connection to the communication AP 202 can be used to route all the traffic through the connection to the proxy server 102. In an embodiment, the communication AP 202 can be configured to route all types of communications such as for example, but not limited to, email, instant messaging, social network communication, broadcast communication, 2-way communication, distributed communication, clustered communication, and the like.

In an embodiment, at 304, the proxy server 102 can be configured to receive the communication message from a sender device 106. In an embodiment, the communication message can include for example, but not limited to, email message, instant message, multimedia message, notification message, and alert message. Each message may include a body and attachment(s) portion. The message may include a body and one or more attachment. In an embodiment, the proxy server 102 can directly receive the message from the sender device 106 or from any other server which manages the communication messages to/from the sender device 106.

In an embodiment, at 306, the proxy server 102 can be configured to compress the body of the message into plain content. The body of the message may include content such as text, smiles, and the like, formatted in different fonts style and color. The body of the message is compressed into plain text, such as to reduce the size of the message. By compressing the messages, the system 100 may reduces the overall bandwidth usage of the user in various ways. In an embodiment, at 308, the proxy server 102 can be configured to identify one or more attachments associated with the message. Most of the communication message includes attachments, particularly emails. In an embodiment, at 310, the proxy server 102 can be configured to remove the one or more attachments. The removed attachments can be securely stored on the cloud 104 such that the service provider will not charge the user for downloading the attachments from the cloud 104.

In an embodiment, at 312, the proxy server 102 can be configured to insert one or more links for the removed attachments. The link described herein can be a uniform resource locator, hyper link, or the like, to direct the user/ receiver to download the attachments. Hyper Text Transfer Protocol (HTTP), HTTP Secure (HTTPS), File Transfer Protocol (FTP), or any other secure file transfer protocol can be used to transfer the attachments by simply clicking on a link. The link can be appended to the message, and a description added to the message that has been stripped of the attachment. The link can lead to the relevant attachment storage area on the cloud 104. The proxy server 102 can be configured to append or add the links to the attachments in the messages. In an embodiment, this link may be password protected if desired by the particular application. By removing the attachments from the messages, the system 100 may reduces the overall bandwidth usage of the recipient. This enable faster download of the non-attachment portions of the message.

In an embodiment, at 314, the proxy server 102 can be configured to route the message to the receiver device 108 in accordance to the zero-rated SLA. In an embodiment, the proxy server 102 acts as a man-in-the-middle (MIIM) between the sender device 106 and the receiver device 108. In an embodiment, at 316, the service provider 110 can charge the receiver in accordance to the zero-rated SLA. The use of the zero-rated SLA provides the receivers to pay only for the message (which is also very less in size due to compression). For example, when the receiver receive the message and download the attachment using the link, the receiver will not be charged by the service provider for using the network to download the attachments, as the service provider is engaged with the zero-rated SLA for the operations performed in the cloud 104. Further, the system 100 can be configured to securely cache the message body and attachments such as to reduce loads on the server, particular when the user access the message from different devices such as smart phone, tablet, and the like.

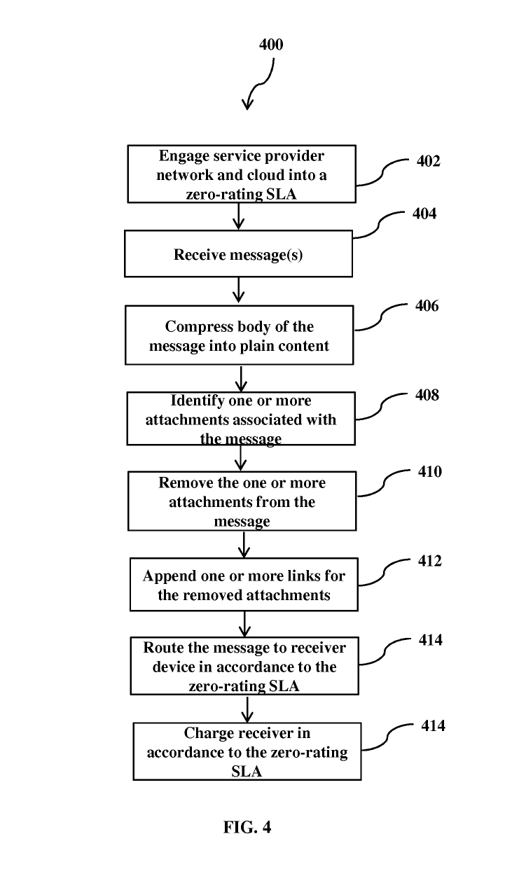

FIG. 4 is a flow chart illustrating a method 400 for provisioning communication services using the proxy server 102 in the cloud 104, according to embodiments disclosed herein. The various steps of the method 400 are summarized into individual blocks where some of the steps can be performed by the proxy server 102, the cloud 104, the sender device 106, the receiver device 108, the service provider network 110, and the like. The method 400 and other description described herein provide a basis for a control program which can be implemented by a microprocessor, microcontroller, or an equivalent thereof.

In an embodiment, at step 402, the method 400 includes engaging the service provider network 110 and cloud 104 into a zero-rated SLA. The zero-rated SLA specifies a zero-rate information associated with traffic exchange between the service provider network 110 and the cloud 104 such that the service provider cannot charge for the usage of network in the cloud 104. The zero-rated SLA engages the service providers not to charge for the operations/traffic incoming or outgoing from the cloud 104. In an embodiment, where the service providers are interested to make changes in their infrastructure, opposed to the zero-rated SLA, the method 400 allows the service providers to provide an option on the sender and receiver device, such as to create a connection with the communication AP 202. Further, the method 400 includes using the communication AP 202 to route all the traffic through the connection to the proxy server 102. In an embodiment, the communication AP 202 can be configured to route all types of communications such as for example, but not limited to, email, instant messaging, social network communication, broadcast communication, 2-way communication, distributed communication, clustered communication, and the like.

In an embodiment, at step 404, the method 400 includes receiving the communication message. The communication message can include for example, but not limited to, email message, instant message, multimedia message, notification message, and alert message. In an example, the method 400 allows the proxy server to receive the communication message from the sender device 106. The method 400 allow the proxy server 102 to directly receive the message from the sender device 106 or from any other server which manages the communication messages to/from the sender device 106.

In an embodiment, at step 406, the method 400 includes compressing the body of the message into plain content. Each message may include a body and attachment(s) portion. The message may include a body and one or more attachment. The body of the message may include content such as text, smiles, and the like, formatted in different fonts style and color. In an example, the method 400 allows the proxy server 102 to compress the body of the message into plain content, such as to reduce the size of the message. By compressing the messages the overall bandwidth usage of the user can be reduced.

In an embodiment, at step 408, the method 400 includes identifying one or more attachments associated with the message. Most of the communication message includes attachments, particularly emails. In an example, the method 400 allows the proxy server 102 to identify one or more attachments associated with the message. In an embodiment, at step 410, the method 400 includes removing the one or more attachments from the message. In an example, the method 400 allows the proxy server 102 to remove the one or more attachments from the message. The method 400 allows the cloud 104 to securely store the removed attachments such that the service provider will not charge the user for downloading the attachments from the cloud 104.

In an embodiment, at step 412, the method 400 includes to appending one or more links for the removed attachments in the message. The link described herein can be a uniform resource locator, hyper link, or the like, to direct the user/receiver to download the attachments. In an example, the method 400 allows the proxy server 102 to insert one or more links for the removed attachments. The link can be appended to the message, and a description added to the message that has been stripped of the attachment. The link can lead to the relevant attachment storage area on the cloud 104. By removing the attachments from the messages, the overall bandwidth usage of the recipient can be reduce thereby enabling faster download of the non-attachment portions of the message.

In an embodiment, at 414, the method 400 includes routing the message to the receiver device 108 in accordance to the zero-rated SLA. The method 400 allows the proxy server 102 to act as a man-in-the-middle (MIIM) between the sender device 106 and the receiver device 108. In an embodiment, at 414, the method 400 includes charging the receiver in accordance to the zero-rated SLA. The use of the zero-rated SLA provides the receivers to pay only for the message (which is also very less in size due to compression). For example, when the receiver receive the message and download the attachment using the link, the receiver will not be charged by the service provider for using the network to download the attachments, as the service provider is engaged with the zero-rated SLA for the operations performed in the cloud 104. Further, the method 400 allows the proxy server 102 to securely cache the message body and attachments such as to reduce loads on the server, particular when the user access the message from different devices such as smart phone, tablet, and the like.

The various steps, blocks, operations, and acts described with respect to the FIGS. 3 and 4, can be performed in sequential order, in random order, simultaneously, parallel, or a combination thereof. Further, in some embodiments, some of the steps, blocks, operations, and acts can be omitted, skipped, modified, or added without departing from scope of the invention.

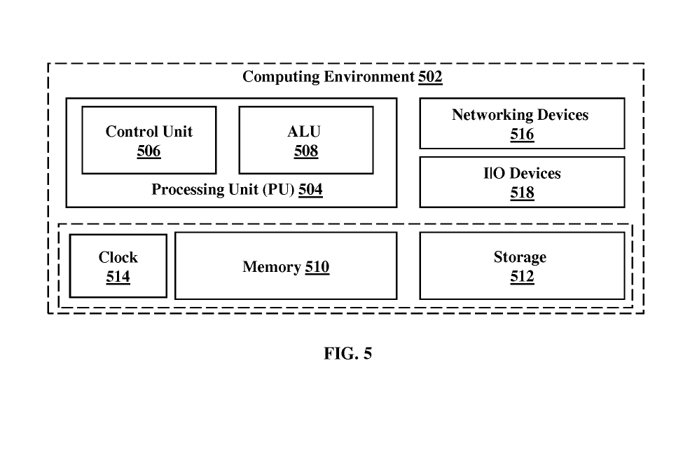

FIG. 5 depicts a computing environment 502 implementing the application, in accordance with various embodiments of the present invention. As depicted, the computing environment 502 comprises at least one processing unit 504 that is equipped with a control unit 506 and an Arithmetic Logic Unit (ALU) 508, a memory 510, a storage unit 512, a clock chip 514, plurality of networking devices 516, and a plurality Input output (I/O) devices 518. The processing unit 504 is responsible for processing the instructions of the algorithm. The processing unit 504 receives commands from the control unit 506 in order to perform its processing. Further, any logical and arithmetic operations involved in the execution of the instructions are computed with the help of the ALU 508.

The overall computing environment 502 can be composed of multiple homogeneous and/or heterogeneous cores, multiple CPUs of different kinds, special media and other accelerators. The processing unit 504 is responsible for processing the instructions of the algorithm. The processing unit 504 receives commands from the control unit 506 in order to perform its processing. Further, any logical and arithmetic operations involved in the execution of the instructions are computed with the help of the ALU 508. Further, the plurality of process units may be located on a single chip or over multiple chips.

The algorithm comprising of instructions and codes required for the implementation are stored in either the memory unit 510 or the storage 512 or both. At the time of execution, the instructions may be fetched from the corresponding memory 510 and/or storage 512, and executed by the processing unit 504. The processing unit 504 synchronizes the operations and executes the instructions based on the timing signals generated by the clock chip 514. The embodiments disclosed herein can be implemented through at least one software program running on at least one hardware device and performing network management functions to control the elements. The elements shown in the FIGS. 1-5 include various units, blocks, modules, or steps described in relation with methods, processes, algorithms, or systems of the present invention, which can be implemented using any general purpose processor and any combination of programming language, application, and embedded processor.

The embodiments herein provides a method and system for provisioning communication service using zero-rated service level agreement (SLA) in a cloud. The embodiments herein provide a mechanism for enhancing the process of email delivery systems at a reasonable system cost. Moreover, the embodiments herein provide a method and system for securely transferring and maintaining electronic communication and associated attachments.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A method for provisioning a communication service using a proxy server in a cloud, the method comprising:
engaging at least one service provider network and said cloud in a zero-rated service level agreement (SLA);
receiving a message;
compressing content of said received message into plain text;
detecting at least one attachment associated with said message;
removing said at least one attachment from said message;
appending at least one link to said at least one removed attachment into said message; and
routing said message to at least one receiver in accordance to said zero-rated SLA.

2. The method of claim 1, wherein said method further comprises charging said receiver for said message in accordance to said zero-rated SLA.

3. The method of claim 1, wherein said zero-rated SLA specifies zero-rate for traffic exchange between said at least one service provider network and said cloud.

4. The method of claim 1, wherein said communication service comprises at least one of an email service, instant messaging service, social network communication service, broadcast communication service, 2-way communication service, distributed communication service, and clustered communication service.

5. The method of claim 1, wherein said message comprises at least one of an email message, instant message, multimedia message, notification message, and alert message.

6. The method of claim 1, wherein said message is sent by a sender associated with said at least one service provider network.

7. The method of claim 1, wherein said message is received by said proxy server.

8. The method of claim 1, wherein said proxy server act as a man-in-the-middle server between said sender and said at least one receiver associated with said at least one service provider network.

9. The method of claim 1, wherein method further comprises establishing a connection between said proxy server and said at least one network service associated with said sender in accordance to said zero-rated SLA.

10. The method of claim 1, wherein method further comprises establishing a connection between said proxy server and said at least one network service associated with said at least one receiver in accordance to said zero-rated SLA.

11. The method of claim 1, wherein said method further comprises storing said at least one detected attachment on said proxy server.

12. The method of claim 1, wherein said method further comprises downloading said at least one attachment from said proxy server using said link.

13. The method of claim 14, wherein said method further charging said receiver for downloading said at least one attachment in accordance to said zero-rated SLA.

14. The method of claim 1, wherein said method further comprises providing a communication access point to route all traffic from said receiver to said proxy server.

15. The method of claim 1, wherein said method further comprises providing said communication access point to route all traffic from said sender to said proxy server in accordance to said zero-rated SLA.

16. The method of claim 14 and claim 15, wherein said communication access point is provided by said at least one service provider network in accordance to said zero-rated SLA.

17. A system for provisioning a communication service over a cloud, the system comprising a proxy server configured to:
engage at least one service provider network and said cloud in a zero-rated service level agreement (SLA);
receive a message;
compress content of said received message into plain text;
detect at least one attachment associated with said message;
remove said at least one attachment from said message;
append at least one link to said at least one removed attachment into said message; and
route said message to at least one receiver in accordance to said zero-rated SLA.

18. The system of claim 17, wherein said proxy server is further configured to charge said receiver for said message in accordance to said zero-rated SLA.

19. The system of claim 17, wherein said zero-rated SLA specifies zero-rate for traffic exchange between said at least one service provider network and said cloud.

20. The system of claim 17, wherein said communication service comprises at least one of an email service, instant messaging service, social network communication service, broadcast communication service, 2-way communication service, distributed communication service, and clustered communication service.

21. The system of claim 17, wherein said message comprises at least one of an email message, instant message, multimedia message, notification message, and alert message.

22. The system of claim 17, wherein said message is sent by a sender associated with said at least one service provider network.

23. The system of claim 17, wherein said message is received by said proxy server.

24. The system of claim 17, wherein said proxy server acts an man-in-the-middle server between said sender and said at least one receiver associated with said at least one service provider network.

25. The system of claim 17, wherein said proxy server is further configured to establish a connection between said proxy server and said at least one network service associated with said sender in accordance to said zero-rated SLA.

26. The system of claim 17, wherein said proxy server is further configured to establish a connection between said proxy server and said at least one network service associated with said at least one receiver in accordance to said zero-rated SLA.

27. The system of claim 17, wherein said proxy server is further configured to store said at least one detected attachment on said proxy server.

28. The system of claim 17, wherein said proxy server is further configured to download said at least one attachment from said proxy server using said link.

29. The system of claim 28, wherein said proxy server is further configured to charge said receiver for downloading said at least one attachment in accordance to said zero-rated SLA.

30. The system of claim 17, wherein said at least one service provider network is configured to provide a communication access point to route all traffic from said receiver to said proxy server in accordance to said zero-rated SLA.

31. The system of claim 17, wherein said at least one service provider network is configured to provide said communication access point to route all traffic from said sender to said proxy server in accordance to said zero-rated SLA.

32. A computer program product for provisioning a communication service using a proxy server in a cloud, the product comprising:
an integrated circuit comprising at least one processor; and
at least one memory having a computer program code within said circuit, wherein said at least one memory and said computer program code with said at least one processor cause said product to:
engage at least one service provider network and said cloud in a zero-rated service level agreement (SLA);
receive a message;
compress content of said received message into plain text;
detect at least one attachment associated with said message;
remove said at least one attachment from said message;
append at least one link to said at least one removed attachment into said message; and
route said message to at least one receiver in accordance to said zero-rated SLA.

33. The computer program product of claim 32, wherein said at least one memory and said computer program code with said at least one processor cause said product to charge said receiver for said message in accordance to said zero-rated SLA.

34. The computer program product of claim 32, wherein said at least one memory and said computer program code with said at least one processor cause said product to download said at least one attachment from said proxy server using said link.

35. The computer program product of claim 34, wherein said at least one memory and said computer program code with said at least one processor cause said product to charge said receiver for downloading said at least one attachment in accordance to said zero-rated SLA.

36. The computer program product of claim 32, wherein said at least one memory and said computer program code with said at least one processor cause said product to provide a communication access point to route all traffic from said receiver to said proxy server in accordance to said zero-rated SLA.

37. The computer program product of claim 32, wherein said at least one memory and said computer program code with said at least one processor cause said product to provide said communication access point to route all traffic from said sender to said proxy server in accordance to said zero-rated SLA.
